(19) United States
(12) Patent Application Publication
(10) Pub. No.: US 2026/0116353 A1
(43) Pub. Date: Apr. 30, 2026

(54) SELF-PROPELLED TRUCK CAMPER

(71) Applicant: Michal Pospieszalski, Star Valley Ranch, WY (US)

(72) Inventor: Michal Pospieszalski, Star Valley Ranch, WY (US)

(21) Appl. No.: 19/228,733

(22) Filed: Jun. 4, 2025

Related U.S. Application Data
(63) Continuation of application No. 19/221,478, filed on May 28, 2025.
(60) Provisional application No. 63/571,167, filed on Mar. 28, 2024.
(60) Provisional application No. 63/655,940, filed on Jun. 4, 2024.

(51) Int. Cl. B60S 9/215; B60P 3/32; B62D 33/033; G05D 1/223; G05D 1/656

(52) U.S. Cl. CPC B60S 9/215; B60P 3/32; G05D 1/656; B62D 33/033; G05D 1/2232

(57) ABSTRACT

A truck camper includes a camper body and legs that may be attached to or integral to the camper body. The legs are movable between retracted and extended positions. In some embodiments, powered wheels may be mounted on the legs to enable self-propelled movement of the camper when the legs are in the extended position. The powered wheels may drive the camper on or off a truck bed. Various control configurations may be provided, including an electronic control unit with sensors for autonomous operation and/or a control system for user control. The control system may include a smartphone application interface. One or more powered wheels may be steerable. The legs may have electronically controlled lengths and may lower the camper body to a basecamp step-up position. Additional features may include tent structures and transformable walls.

### CROSS-REFERENCE TO RELATED APPLICATIONS

This application claims the benefit of U.S. Provisional Patent Application No. 63/655,940, filed Jun. 4, 2024, entitled “SELF-PROPELLED TRUCK CAMPER,” the technical disclosure of which is incorporated herein by reference for all purposes consistent with the present application. This application claims the benefit of U.S. patent application Ser. No. 19/221,478, filed May 28, 2025, entitled “SELF-PROPELLED AND REVERSE SELF-STEERING QUAD CAMPER TRAILER,” which claims the benefit of U.S. Provisional Patent Application No. 63/571,167, filed Mar. 28, 2024, entitled “SELF-PROPELLED AND REVERSE SELF-STEERING QUAD CAMPER,” the technical disclosures of which are incorporated herein by reference for all purposes consistent with the present application.

### BACKGROUND

### Field of the Technology

The disclosure relates to an improved truck camper system designed to enhance the usability and convenience of mounting and dismounting the camper from the truck.

### Description of the Related Art

Truck campers are used for recreation, providing a compact and mobile living space that is attached and transported on a truck bed. Truck campers are mounted and secured to the truck bed using mechanical systems.

Dismounting the truck camper from the truck involves several steps for example: first, remove the mechanical fasteners of the mechanical system securing the truck camper to the truck; second, separate extendable legs are attached to the truck camper; third, the legs are extended to lift the truck camper off the truck; and fourth, the truck is driven out from underneath the truck camper. Positioning the camper correctly at a campsite or at home can be challenging, especially on uneven terrain. Since the camper does not move once it is off the truck, it is important to position it correctly at the desired location before dismounting it.

Mounting the truck camper on the truck also presents challenges. The process requires precise alignment to ensure the proper position of the camper on the truck bed. This involves backing the truck up, so the truck camper is in the correct position under the truck camper, then shortening the legs to place the camper on the truck. Finally, the mechanical fasteners must be securely connected. Ensuring the correct truck camper position and securely fastened the truck camper to the truck is crucial for safe travel and use.

The present invention seeks to address these challenges by providing a truck camper system that simplifies the process of mounting and dismounting the truck camper from the truck, while also offering enhanced features for improved usability and convenience.

### SUMMARY

A truck camper and related systems where in some embodiments, a truck camper may include a camper body and legs attached to the camper body. Each leg may be movable between a retracted position and an extended position. Powered wheels may be mounted on the legs. When provided, the powered wheels may be configured to propel the camper when the legs are in the extended position.

The powered wheels, when present, may drive the camper on or off a truck bed. An electronic control unit and sensors may be provided for autonomously driving the camper on or off a truck bed. A control system may be operatively connected to the powered wheels to allow a user to control movement of the camper. The control system may include a smartphone application interface.

At least one of the powered wheels may be steerable. Multiple powered wheels may be independently steerable. Each leg may have an electronically controlled length.

In certain embodiments, a truck camper may include a camper body having exterior walls and legs integral to the camper body. Each leg may have a retracted position and an extended position. In the extended position, the legs may support the camper. The legs may transition from the retracted position to the extended position by electronic control.

The truck camper may be provided with a truck having a configurable truck bed with removable sidewalls. The legs may adjust their length to lower the camper body to less than 12 inches from ground level. Each leg may retract to a retracted position within the camper body. In the retracted position, each leg may be flush with or inboard of the exterior walls.

A wheel may be mounted on each leg. Each wheel may include a propulsion motor configured to drive the wheel and/or a steering motor configured to pivot the wheel for directional control.

In various embodiments, a truck camper may include a camper body having a floor and legs integral to the camper body. The legs may be capable of lowering the camper body to a basecamp step-up position. In the basecamp step-up position, the floor may be positioned at a standard step-up distance from the ground.

A tent structure may be integrated with the camper body and designed for deployment when the camper is in the basecamp step-up position. A rear wall may be hinged at a top edge to fold upward forming a deck roof. The truck bed may be configurable to carry recreational vehicles when the camper is removed from the truck bed.

### BRIEF DESCRIPTION OF THE DRAWINGS

FIG. 1 illustrates a right side view of a truck camper with all the components retracted.

FIG. 2 illustrates a right rear perspective view of the truck camper with most of the components retracted.

FIG. 3 illustrates a right side view of the truck camper with the components expanded.

FIG. 4 illustrates a left side rear perspective view of the truck camper with components expanded.

FIG. 5 illustrates the truck camper embarking onto the truck bed.

FIG. 6A illustrates a right side view of the truck camper lowering onto the truck bed with the front and rear legs of the camper extended.

FIG. 6B illustrates a right side view of the truck camper on the truck bed, with the truck camper's front and rear legs extended and the front wheels in the retracted orientation aligning to the recessed opening on the camper.

FIG. 6C illustrates a right side view of the truck camper on a truck bed with the front legs retracted.

FIG. 7 illustrates a right side view of the truck camper on the truck with all external components expanded, including the side awning, rear awning, rear deck, and pop-up top.

FIG. 8 illustrates a left side view of the truck camper on the truck with all external components expanded, including the awning, slide-outs, and pop-up elements.

FIG. 9 illustrates a right rear perspective view of the truck camper on the truck with the pop-up roof expanded and the right window opened.

FIG. 10 illustrates the truck with the bed having built-in cabinets.

### DETAILED DESCRIPTION

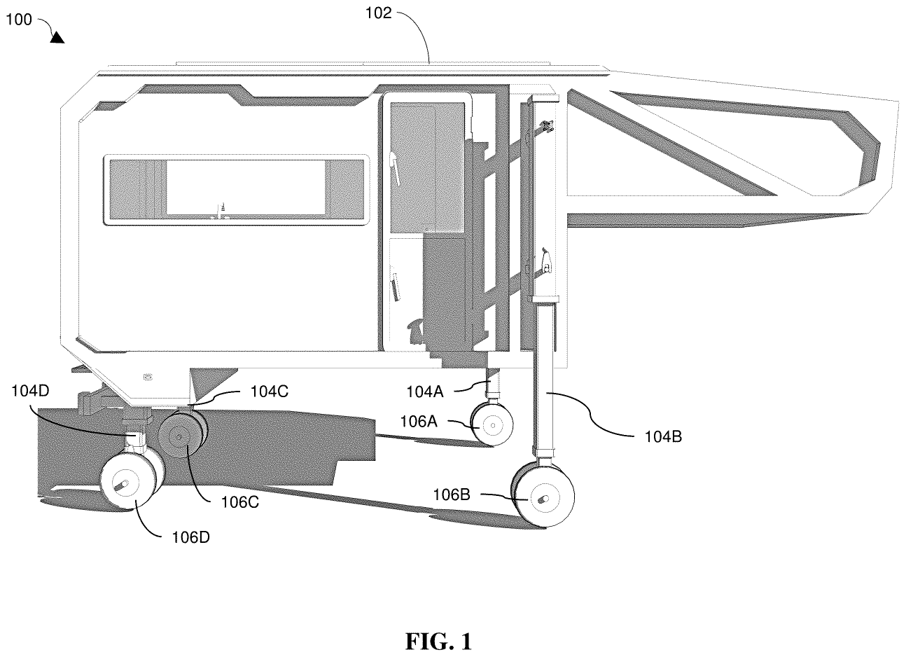

FIG. 1 illustrates a right side view 100 of a truck camper 102 with all the components retracted. The truck camper 102 is shown with four legs in extended positions: left front leg 104A, right front leg 104B, left rear leg 104C, and right rear leg 104D. Each leg has a corresponding wheel mounted at its lower end: left front wheel 106A mounted on leg 104A, right front wheel 106B mounted on leg 104B, left rear wheel 106C mounted on leg 104C, and right rear wheel 106D mounted on leg 104D. The legs are shown extending downward from the truck camper body 102, positioning the wheels to support the camper 102 above ground level. The truck camper 102 is depicted with its exterior components in their retracted or closed positions, presenting a compact profile suitable for transport or storage. The extended legs with wheels enable the self-propelled functionality of the truck camper 102, allowing it to maneuver independently when dismounted from a truck bed.

The legs are permanently installed when the camper 102 is manufactured, making them integral to the camper structure. Unlike traditional removable jack stands that can only be attached or stowed away, these legs retract into the camper body when not needed. The retraction mechanism allows the legs to telescope, slide, or otherwise draw back into recesses in the camper structure. The legs may be integrated within the walls, frame, or undercarriage of the camper body. The retracted position refers to the legs being positioned for storage during transport, where the legs are stored within or against the camper body.

The self-propelled truck camper 102 has steerable wheels that enable the truck camper 102 to move in any direction. If all four wheels 106A, 106B, 106C, and 106D can steer, the camper 102 may even be able to move sideways.

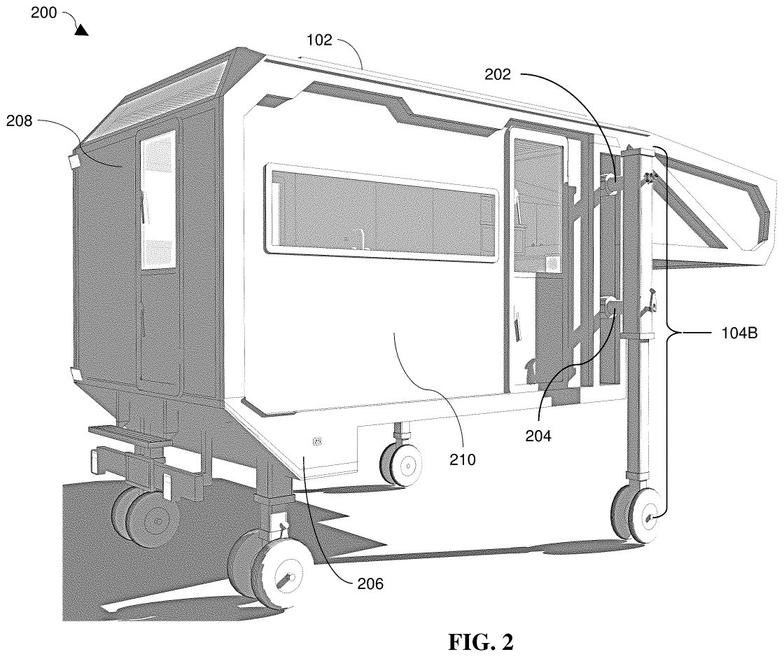

FIG. 2 illustrates a right rear perspective view 200 of the truck camper 102 with the legs extended and other expandable components retracted. The front right leg 104B is shown in its extended position with its dual-slide mechanism comprising a top slider 202 and a bottom slider 204. These sliders enable the leg 104B to move outward from its stored position where it would normally be flush or inboard of the outside wall of the camper. When activated, the top slider 202 and bottom slider 204 work in conjunction to push the entire leg assembly outward, clearing the side of the truck bed before the leg 104B extends downward. This dual-slide configuration provides stable support and ensures proper clearance during deployment. The leg mechanism is permanently installed and integral to the camper structure, designed to retract into the camper body when the camper 102 is mounted on the truck bed. The truck camper 102 is shown supported on its four wheels, with the pull-out kitchen 206 in its retracted position and the rear wall 208 and passenger side wall 210 visible.

The leg 104B in the retracted position is stored flush or inboard of the outside wall and, when activated, the leg 104B is pushed outward for example with a pneumatic piston or other mechanism. Once clear of the truck side, the leg 104B extends downward. While this embodiment utilizes the dual-slide mechanism with top 202 and bottom sliders 204, the front legs may be implemented using various alternative mechanical systems such as telescopic legs that slide out horizontally and then extend downward.

The legs may use rotating and telescoping legs that rotate 90 degrees to a vertical position before extending downward. Another option is angled mounting with a sliding mechanism that is on an angle and moves the legs out enough to clear the truck bed. Another option would be to pivot and extend mechanisms with legs hinged at top and an extension at the bottom leg attachment point so the bottom extension pushed the leg out to an angle where the leg will clear the truck bed when extended. The front leg with extension and retraction for the wheel may be implemented with other mechanisms.

The leg adjustment may involve electric motors connected to screw threads (lead screws or ball screws) that convert rotational motion into linear motion to adjust the leg height. Pneumatic or hydraulic cylinders may be utilized to extend and retract the legs. Other mechanisms and techniques may be used to control the leg length. Each leg may have an electronically controlled length, allowing precise positioning of the camper 102 for various purposes including leveling, height adjustment, and transitioning between transport and camping configurations.

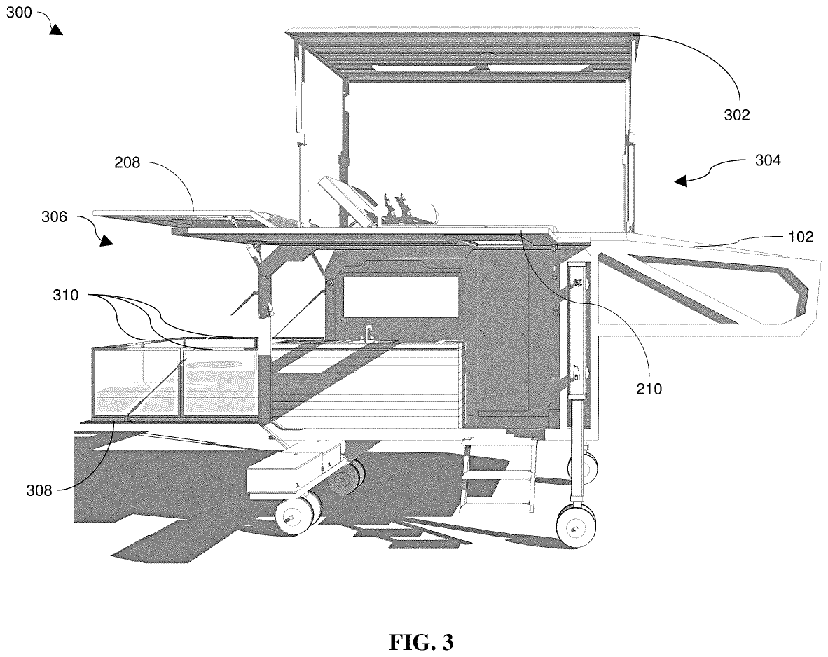

FIG. 3 illustrates a right side view 300 of the truck camper 102 with the components expanded. The truck camper 102 may provide hard sidewalls (like the rear wall 208 and the passenger side wall 210) that transition into ceiling/awnings providing large solid surfaces, in contrast to being made out of fabric that can be whipped about and damaged by the wind.

The truck camper 102 is shown with its transformable rear deck system 306 fully deployed. In this embodiment, the system includes a rear wall 208 that is hinged at its top edge, allowing it to fold upward to form a deck roof. The rear wall 208 is the outer rear wall of the truck camper 102 that normally encloses the living space. When folded upward, it creates a covered outdoor space extending from the rear of the camper 102.

A second rear interior wall 308 hinges at the bottom and folds down forming the floor of the rear deck 306, creating a fully enclosed deck space with both roof and floor. The rear deck floor 308 is shown supported by cables that run from the top corners of the rear wall 208 of the truck camper 102 to the rear edge of the floor 308 when in the down position. The rear wall 208 when folded upward may be supported by gas struts, mechanical arms, cables, or other support mechanisms.

The rear deck floor 308 is shown with railings 310 on the left side, right side and rear side. The railings 310 may fit into mounting openings on the floor 308, or may be attached to the floor 308 via hinges and rotate up when the floor 308 is deployed to form the railings 310.

The truck camper 102 is also shown with a rooftop lounge 304 with a pop-up top roof 302. The pop-up roof 302 is depicted in its raised position, creating the rooftop lounge area 304 above the main living space. The truck camper 102 may have a raising roof and offer rooftop storage on top of the raising roof 302. The extended configuration demonstrates how the truck camper 102 transforms from its compact travel form to provide multiple outdoor living spaces when stationed at a campsite.

The passenger side wall 210 is shown in its open position. The passenger side wall 210 is hinged at its top edge and raised upward to form a roof, creating an awning for a covered side area. In the closed position the side wall 210 may extend to or past the floor of the truck camper 102. When in the closed position, the passenger side wall 210 may have a window that opens up to the kitchen. The truck camper 102 may also have a 180-270 degree expanding awning on the passenger side wall 210 (such that an awning is available even if the side wall 210 is closed).

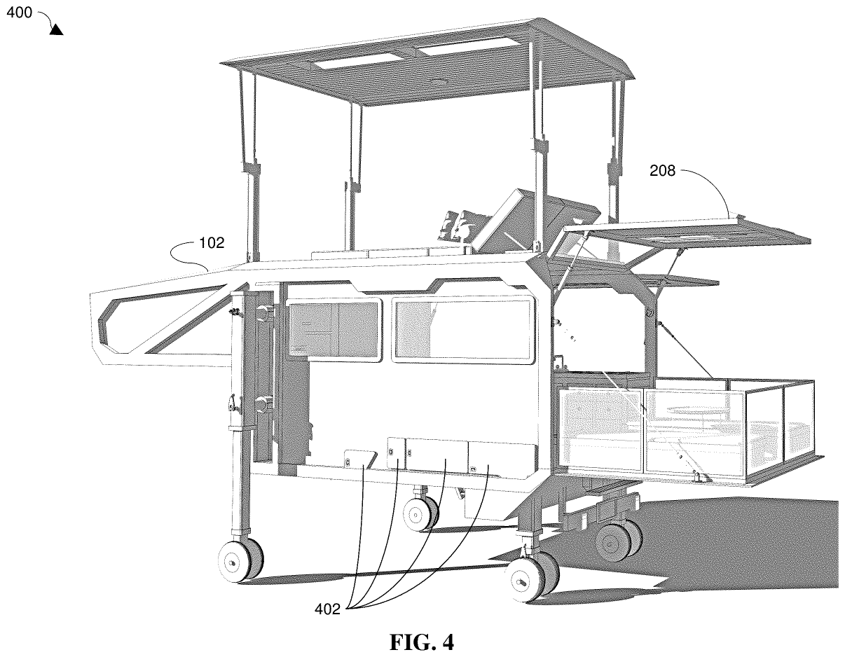

FIG. 4 illustrates a left side rear perspective view 400 of the truck camper 102 with components expanded. The truck camper 102 is shown with cabinets and access openings 402 visible on the left side of the camper body. These storage compartments 402 provide exterior access to the camper's storage areas.

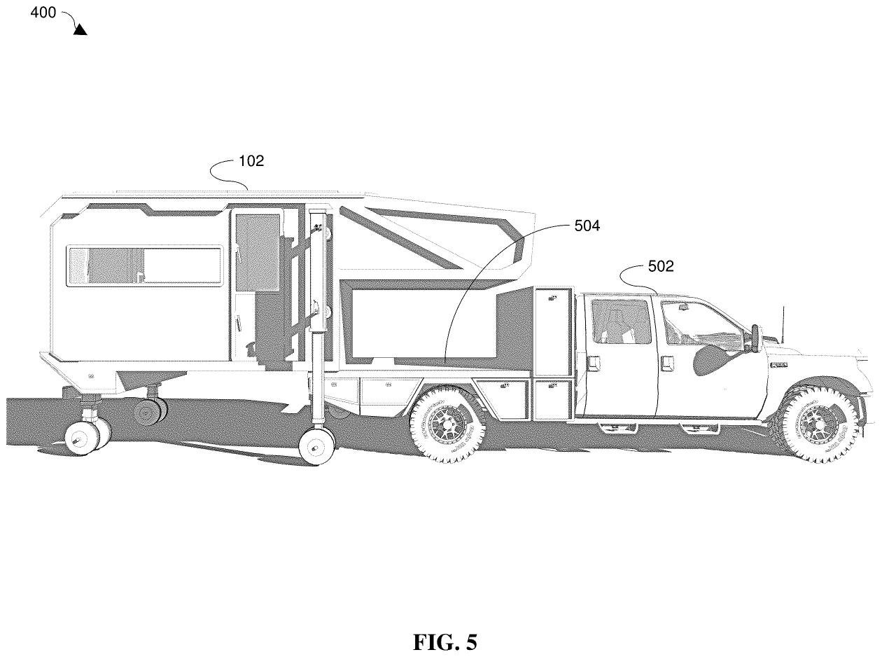

FIG. 5 illustrates the truck camper 102 embarking onto the truck 502. The view 500 shows the truck 502 with its truck bed 504 positioned to receive the truck camper 102. The self-propelled truck camper 102 is shown using its powered wheels to drive itself onto the truck bed 504. The front wheels of the truck camper 102 are already positioned on the truck bed 504 while the rear portion remains supported by the extended rear legs. This demonstrates the self-propelled capability that allows the truck camper 102 to mount itself onto the truck 502 without requiring the truck 502 to be precisely backed under the camper 102.

The self-propelled truck camper 102 has two or four powered wheels, for example two front truck-camper wheels powered to propel themselves forward or reverse and steer through 180° or 360°. The powered wheels may be self-contained motor units, where the electric motor powering the wheel is inside the wheel/tread. The wheels on the truck camper 102 may have treads for rough terrain or snow. The powered wheels enable the truck camper 102 to precisely align with and drive onto the truck bed 504 during the mounting process.

The truck camper 102 may move itself under its own power on-to and off-of the truck bed 504 via a remote control. The truck camper 102 may autonomously navigate itself on-to and off-of the truck bed 504, for example via AI. The camper 102 may orient itself via cameras and/or lidar/radar. The self-propelled truck camper 102 may incorporate a sensor-based alignment system to facilitate precise autonomous positioning onto the truck bed 504. This system may utilize various sensors such as cameras, lidar, radar, distance sensors, and angle sensors to detect the truck's location and orientation relative to the truck camper 102. An Electronic Control Unit (ECU) may process the sensor data and generates control signals for the powered wheels 106A, 106B, 106C and 106D. When the truck bed 504 is in sensor range, the truck's position is determined, and the ECU calculates a path for the truck camper 102 to mate with the truck bed 504. The wheel controllers receive commands from the ECU to steer and propel the wheels, allowing the camper 102 to autonomously move along the calculated path. Continuous sensor feedback enables the ECU to make real-time adjustments to the path as needed. As the truck camper 102 approaches the truck bed 504, the system may ensure precise final positioning by making fine adjustments based on the sensor data. This allows the camper 102 to accurately self-align over the truck bed. The sensor-based system may also be operated via a remote control or smartphone app, providing manual steering of the truck camper 102 when detached.

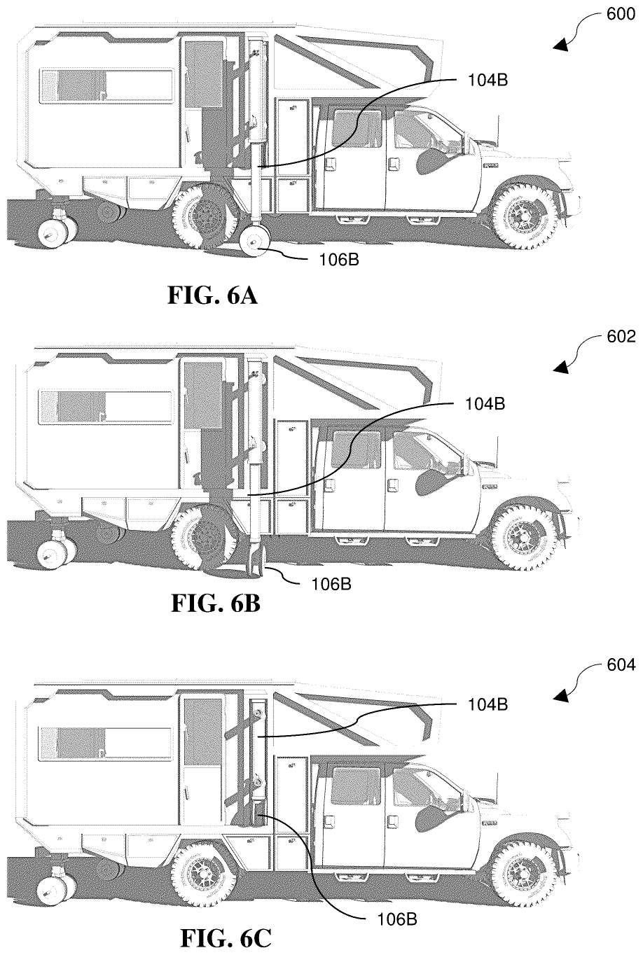

FIGS. 6A, 6B and 6C illustrate a sequence showing the retraction of the front leg 104B and wheel 106B as the truck camper 102 prepares for transport on the truck. The sequence includes extended-leg configuration 600, wheel-rotation stage 602, and retracted-leg configuration 604.

In extended-leg configuration 600, the truck camper 102 is shown positioned on the truck bed with both front and rear legs extended. The front right leg 104B is fully extended downward with its wheel 106B oriented for forward/reverse movement.

In wheel-rotation stage 602, the retraction sequence begins with the front wheel 106B rotating to a stowed orientation, pointing inward toward the truck camper 102. This repositioning aligns the wheel 106B with a recessed opening in the camper body, preparing for the leg 104B to retract. The front leg 104B remains extended at this stage while the wheel 106B has completed its rotation.

In retracted-leg configuration 604, the retraction sequence is complete. The front leg 104B has been fully retracted upward into the truck camper 102, with the wheel 106B nested within the camper body. The dual-slide mechanism comprising the top slider 202 and bottom slider 204 has drawn the entire leg assembly inward, positioning it flush with or inboard of the camper outside wall. The rear legs 104C and 104D remain extended throughout this sequence, maintaining support for the rear of the camper 102 during the front leg retraction process. Once both front legs are retracted, the truck camper 102 is secured to the truck bed 504 and ready for highway transport.

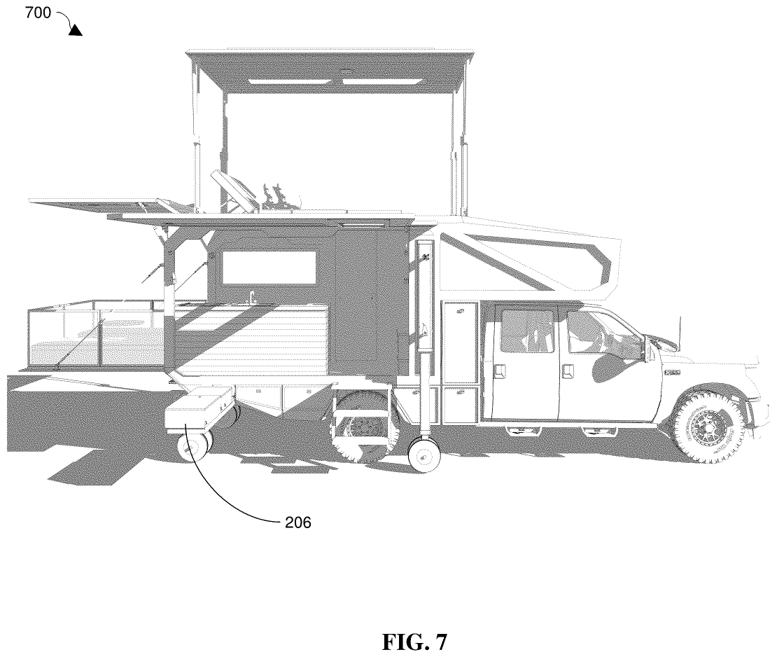

FIG. 7 illustrates a right side view 700 of the truck camper 102 on the truck 502 with all external components expanded. The slide-out outdoor kitchen 206 is shown in its extended position on the passenger side of the truck camper 102. The slide-out kitchen 206 provides outdoor cooking capabilities while the truck camper 102 remains mounted on the truck bed 504.

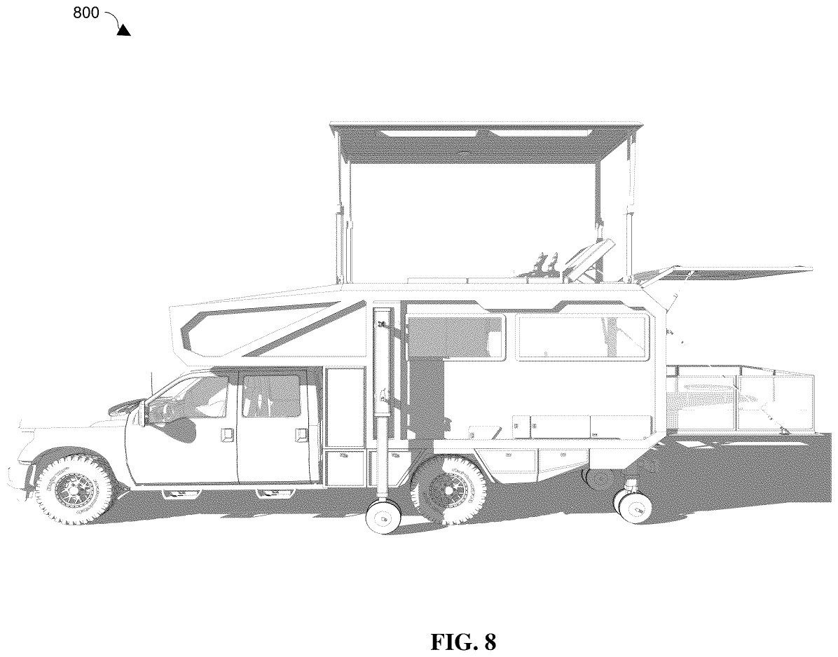

FIG. 8 illustrates a left side view 800 of the truck camper 102 on the truck 502 with all external components expanded. From this driver's side perspective, the truck camper 102 shows the expanded configuration while mounted on the truck bed 504.

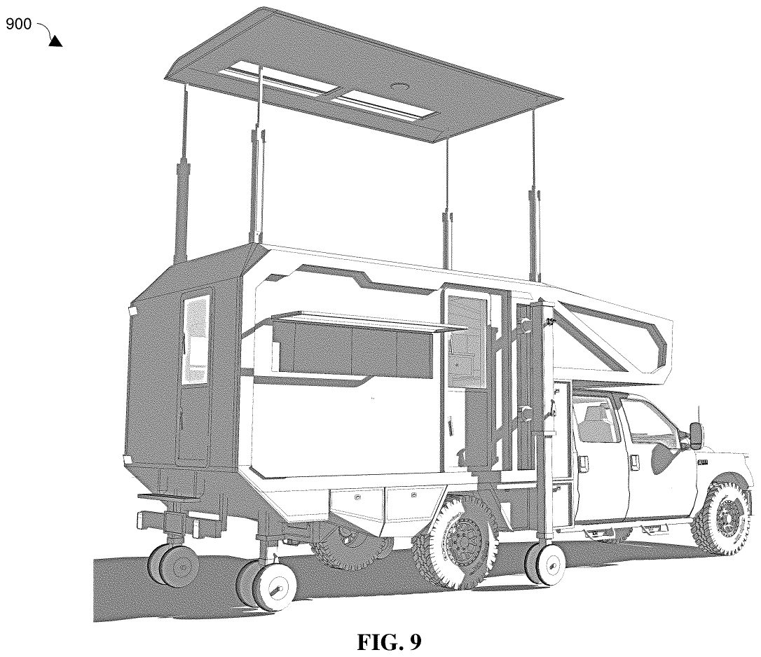

FIG. 9 illustrates a right rear perspective view 900 of the truck camper 102 on the truck 502 with the pop-up roof 302 expanded and the right window opened. The passenger side wall 210 is shown in its closed position with a window in the side wall 210 that opens to provide access to the kitchen area from outside. This window allows serving and ventilation capabilities while the main passenger side wall 210 remains closed.

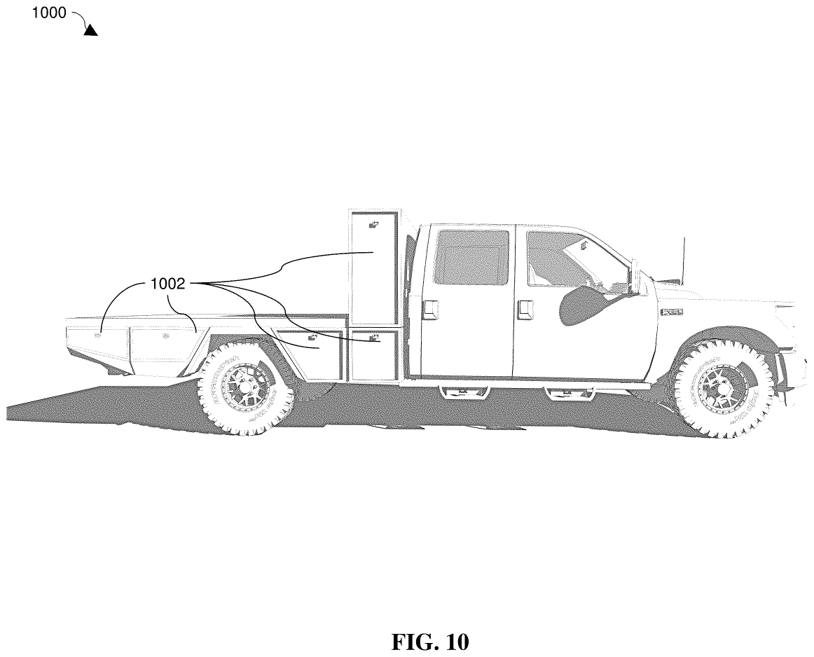

FIG. 10 illustrates the truck 502 with the bed 504 having built-in cabinets 1002. The truck 502 may be a cab with a customized truck bed 504, rather than a standard pickup truck. The truck bed 504 may have side drawers that are accessible from the side of the truck bed 504. These sidewall drawers and cabinets 1002 provide additional storage space and organizational options. The inclusion of sidewall drawers allows the truck bed 504 to accommodate standard truck campers or truck campers with slide-out expansion units. The truck bed sidewalls may be removable, providing greater flexibility in configuring the truck bed 504 to suit various needs and applications. The truck bed 504 may be configurable into different modes to serve a variety of purposes. For example, when not carrying the truck camper 102, the truck bed 504 may be configured to carry recreational vehicles such as snowmobiles, motorcycles, or all-terrain vehicles (ATVs), with secure mounting points and mechanisms for easy loading and unloading. For professional use, the truck bed 504 may be outfitted with tool storage, equipment racks, and other features to serve as a versatile work vehicle. The truck bed 504 may accept many different truck campers and configurations.

A self-propelled truck camper that can be mounted to a truck. The truck camper and truck make up a camper system. The truck may be a cab with a customized truck bed, so it is not a pickup truck. The truck bed may have sidewalls that contain drawers or cabinets (not shown in the drawings). The sidewalls may be removable. The truck bed with the truck-bed sidewall installed may work with existing truck-campers designed for pickup trucks.

The self-propelled truck camper may drive itself on and off the truck bed.

The truck bed may be configurable, and the truck bed may accept many different truck campers.

The self-propelled truck camper has two or four powered wheels, so for example two front truck-camper wheel powered to go propel themselves forward or reverse and steer through 180° or 360°. The powered wheels may be on legs and retract/extend in the up/down direction.

One or more of the powered wheels may be steerable, allowing the camper to be maneuvered in various directions. In some configurations, multiple powered wheels are independently steerable, enabling complex movements including sideways motion and rotation in place.

The term “powered wheel” as used in this specification refers to a wheel having an integrated or operatively connected motor capable of rotating the wheel to propel the truck camper. The motor may be electric, hydraulic, pneumatic, or any other suitable type providing motive force to the wheel. The powered wheel may include the motor housed within the wheel hub itself or may have the motor mounted adjacent to the wheel with power transmission through gears, belts, chains, or other mechanical linkages.

The legs can adjust their height under control from the Electronic Control Unit (ECU). The ECU may power control the motor speed and direction to precisely raise or lower the legs, offering high precision and the ability to hold positions firmly without drift

These systems may be managed by an ECU. The ECU may set the legs to a desired height.

To ensure accurate and stable positioning, the ECU may utilize feedback from leg sensors. These sensors may include position encoders, load cells, linear potentiometers, or other sensing mechanisms to provide real-time data on the leg length and possible the load on the leg. The ECU may process this data to make continuous adjustments to the leg length to enable various features of the truck camper.

‘Electronically controlled length’ refers to any mechanism capable of adjusting the length of the leg in response to electronic control signals, including but not limited to electric motor-driven screws, hydraulic cylinders with electronic valves, pneumatic cylinders with electronic valves, linear actuators, or combinations of these mechanisms. The electronic control may be through direct wiring, wireless signals, or any other electronic communication method.

The camper may move itself under its own power, for example directed via a remote control, to embark (i.e. move onto) or disembarked (i.e., move off of) the truck.

The truck camper may autonomously navigate itself on-to and off-of the truck bed, for example via AI. The camper may orient itself via cameras and/or lidar/radar.

The term “steerable” means capable of changing the direction of travel of the wheel by rotating the wheel assembly about a substantially vertical axis. A wheel may be steerable through various ranges of rotation, including but not limited to 90 degrees, 180 degrees, 360 degrees, or any range between these values. The term “independently steerable” means each wheel can be steered separately from other wheels, allowing for complex maneuvering patterns.

The self-propelled truck camper may be moved and oriented under its own power, for example via remote control at a campsite. The truck-camper may lower itself to the ground after removing itself from the truck. The truck camper may use the powered legs to auto level the truck camper when its off the truck.

The wheels the truck-camper may have treads for rough terrain or snow.

The powered wheels may be self-contained motor units, i.e. where the electric motor powering the wheel is inside the wheel/tread. The self-propelled truck camper may have front wheels that can steer 180 degrees and the rear wheel may be powered to propel the truck camper with the rear truck camper wheels being electrically powered by self-contained motor units.

The truck-camper may incorporate a locking mechanism to the truck bed strong enough to lift the truck. When lifting the truck the self-propelled truck-camper may be used to jack up the rear axle of the truck for tire changes/service.

“Basecamp Mode” is when the truck camper is detached from the truck at a campsite. 208

The control system may include various configurations for operating the powered wheels and legs. In some embodiments, this includes a smartphone application interface that allows users to control camper movement remotely.

The truck camper may have a slide out outdoor kitchen. The slide out kitchen may be on the passenger side.

In Basecamp Mode integrated tent structures may be deployed creating covered or enclosed spaces. For example, the front area under the bedroom overhang may be configured as a tented lounge.

‘Basecamp step-up position’ refers to a configuration where the truck camper has been lowered by setting the legs length such that the floor of the camper is positioned at a height that allows easy entry without requiring a ladder or multiple steps. A “standard step-up distance” is having the floor of the camper be between 7 and 12 inches from the ground, similar to a standard residential stair riser height. This positioning enables comfortable access to the camper and facilitates the deployment of ground-based accessories such as tent structures.

The tent structures may be fabric-based enclosures that are stored within or attached to the camper body when not in use. These structures are specifically designed for deployment when the camper is in the basecamp step-up position, taking advantage of the lowered height to create additional enclosed living spaces at ground level. The tent structures may attach to the camper body through zippers, snaps, hooks, magnetic connections, or other removable fastening systems.

The enclose space may be formed with awnings that are fabric materials. The structure may be in the form of arms that pivot from a central location for example from a corner and have awning supports that rotate out to provide a roof awning covering up to 270 degrees. The arms may be stored by rotating the arms to run parallel to the side of the truck camper, and enclosed in a cover. The tented lounge may be deployed with the rear and passenger side walls open or closed. These areas are more usable and easier to deploy when the truck camper can lower itself to the ground.

The truck camper may have a raising roof such and offer rooftop storage on top of the raising roof.

The truck camper may include a battery, the battery may be located under the camper in the rear of the camper. The battery powers the front and/or rear self-propelled wheels through an Electronic Control Unit (ECU). The ECU controls the turning of the camper wheels to steer. The powered wheels enable remote control maneuvering, such as through a phone app.

‘Control system’ includes any device or combination of devices capable of sending control signals to the powered wheels, including but not limited to handheld remote controls, smartphone applications, tablet applications, dedicated control panels, joysticks, wireless key fobs, or any wireless or wired control interface. The control system may include both manual control options for user operation and automatic control features for pre-programmed movements.

The truck camper hard side awning may be operated by electric power. The hard awning is designed to withstand wind conditions often encountered at camping locations, unlike typical soft camper awnings prone to damage in windy conditions. The awning may have a window that matches the kitchen opening, so when in the down position, the awning windows align with the opening on the truck camper side wall.

The truck camper may be equipped with a low-voltage air-conditioning system, a heat pump offering both heating and cooling capabilities, or a direct current (DC) air conditioner. It may also feature diesel-powered room heat, hydronic floor heat, and water heating capabilities.

Via adjusting the height of the 4 individual legs, the truck camper may enable automatic leveling of the camper on various surfaces and terrains using the legs. The adjustable leg height allows for raising the trailer for increased ground clearance in rough/camping terrains, clearing obstacles. An ‘auto-level’ feature controlled by the ECU can make the camper level when on uneven ground by manipulating the individual wheel leg lengths for example via the air suspension system.

The adjustable leg height system may also be hydraulic or another type that allows the ECU to manipulate individual wheel suspension heights. When on uneven ground, the user can enable an ‘auto-level’ feature, for example on the remote control, and the legs controlled by the ECU will make the camper level.

The truck camper may have additional features such as a slide-out removable toilet, solar power cells as part of a solar power system for charging the batteries, an external shower enclosure and system, and a parking brake.

All liquid storage tanks may be located in the climate-controlled part of the camper, allowing the heating system to keep the camper above freezing temperatures at all times.

The self-propelled truck camper may incorporate a sensor-based alignment to facilitate precise autonomous positioning onto the truck bed. This system may utilize various sensors such as cameras, lidar, radar, distance sensors, and angle sensors to detect the truck's location and orientation relative to the truck camper. An Electronic Control Unit (ECU) processes the sensor data and generates control signals for the powered wheels.

When the truck bed is in sensor range the truck's position is determined, and the ECU calculates a path for the truck camper to mate with the truck bed. The wheel controllers receive commands from the ECU to steer and propel the wheels, allowing the camper to autonomously move along the calculated path. Continuous sensor feedback enables the ECU to make real-time adjustments to the path as needed.

As the truck camper approaches the truck bed, the system may ensure precise final positioning by making fine adjustments based on the sensor data. This allows the camper to accurately self-align over the truck bed.

The sensor-based system may also be operated via a remote control or smartphone app, providing manual steering of the truck camper when detached so it can be moved the proper location at the camp site or a home/storage site.

‘Operatively connected’ means connected in a way that enables the transfer of signals, power, or mechanical force between components, whether through direct physical connection, wireless communication, hydraulic lines, pneumatic lines, electrical wiring, mechanical linkages, or any other suitable connection means that allows one component to control or influence another component.

The system may derive power from the truck camper's battery, ensuring independent operation from the truck's power supply.

A quad camper trailer can drive itself onto the hitch, using the sensor to automatically align itself, for example with a single button press on the camper or on the remote control.

What is claimed is:

1. A truck camper comprising:
a camper body;
a plurality of legs attached to the camper body, each leg movable between a retracted position and an extended position; and
a powered wheel mounted on each leg, where the powered wheels are configured to propel the camper when the legs are in the extended position.

2. The truck camper of claim 1, where the powered wheels are configured to drive the camper on or off a truck bed.

3. The truck camper of claim 1, further comprising:
an electronic control unit and sensors for autonomously driving the camper on or off a truck bed.

4. The truck camper of claim 1, further comprising:
a control system operatively connected to the powered wheels to allow a user to control movement of the camper.

5. The truck camper of claim 4, where the control system includes a smartphone application interface.

6. The truck camper of claim 1, where at least one of the powered wheels is steerable.

7. The truck camper of claim 6, where a plurality of the powered wheels are independently steerable.

8. The truck camper of claim 1, where each leg has an electronically controlled length.

9. A truck camper comprising:
a camper body having exterior walls; and
a plurality of legs integral to the camper body, each leg having a retracted position and an extended position, where in the extended position the leg supports the camper, and the leg can transition from the retracted position to the extended position by electronic control.

10. The truck camper of claim 9, further comprising a truck with a configurable truck bed having removable sidewalls.

11. The truck camper of claim 9, where the legs can adjust their length to lower the camper body to less than 12 inches from ground level.

12. The truck camper of claim 9, where each leg retracts to a retracted position within the camper body.

13. The truck camper of claim 12, where each leg in the retracted position is flush with or inboard of the exterior walls.

14. The truck camper of claim 9, further comprising:
a wheel mounted on each leg.

15. The truck camper of claim 14, where each wheel comprises a propulsion motor configured to drive the wheel; and a steering motor configured to pivot the wheel for directional control.

16. A truck camper comprising:
a camper body having a floor; and
legs integral to the camper body capable of lowering the camper body to a basecamp step-up position, where in the basecamp step-up position the floor is positioned at a standard step-up distance from the ground.

17. The truck camper of claim 16, further comprising a tent structure integrated with the camper body and designed for deployment when the camper is in the basecamp step-up position.

18. The truck camper of claim 16, further comprising a rear wall hinged at a top edge to fold upward forming a deck roof.

19. The truck camper of claim 16, further comprising a truck having a configurable truck bed with removable sidewalls.

20. The truck camper of claim 19, where the truck bed is configurable to carry recreational vehicles when the camper is removed from the truck bed.
